(19) United States
(12) Patent Application Publication
(10) Pub. No.: US 2008/0198592 A1
(43) Pub. Date: Aug. 21, 2008

(54) SEMICONDUCTOR LIGHT EMITTING DEVICE ARRAY CHIP AND EXPOSURE LIGHT SOURCE APPARATUS

(75) Inventor: Yoshinobu Sekiguchi, Machida-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/031,087

(22) Filed: Feb. 14, 2008

(30) Foreign Application Priority Data
Feb. 16, 2007 (JP) 2007-036360

(51) Int. Cl. F21K 7/00

(52) U.S. Cl. 362/227

(57) ABSTRACT

A light emitting device array chip comprises a light emitting device array having a plurality of light emitting devices arranged two-dimensionally on a substrate. The profile of the light emitting device array chip is a parallelogram with two long sides and two short sides forming an acute or obtuse angle. The light emitting device array has a plurality of blocks arranged along the long sides, and each block has a plurality of segments arranged along the long sides. In each segment, a plurality of light emitting devices are arranged in a plurality of rows along the long sides and also in a plurality of rows along the short sides, and they are connected to a common electrode. At least a single wire is provided for electrically connecting a plurality of light emitting devices selected from different segments, and an electrode pad for wire bonding is formed on the at least single wire. The electrode pad is arranged at the side of the long side of a corner of the acute angles on the array chip.

### BACKGROUND OF THE INVENTION

1. Field of the Invention

This invention relates to a semiconductor light emitting device array chip and an exposure light source apparatus using the same. More particularly, the present invention relates to a semiconductor light emitting device array chip to be used for an LED scanner or a LED printer and an exposure light source apparatus using the same.

2. Description of the Related Art

In the field of copying machines, printers using LED arrays as light source for drawing images with high density dots such as 600 dpi or 1,200 dpi have recently been and currently being marketed.

In an LED array for realizing 1,200 dpi, light emitting spots are arranged in a row on a semiconductor at a pitch of about 21.2 μm with a size of about 10 μm of the light source to realize high definition printing by means of micro-spots.

However, efforts are being taken to develop LED arrays that accommodate 2,400 dpi in order to meet the demand for higher definitions. Then, light sources having light emitting spots arranged at a pitch of about 10.6 μm on a semiconductor and a size of about 5 μm will be required.

As pointed out above, exposure light source apparatus have been realized for printer heads of printers with chips arranged in a plurality of rows, each chip having light emitting spots arranged in a row, in order to draw images with 1,200 dpi. FIG. 6 of the accompanying drawings is a schematic top view of such an exposure light source apparatus, illustrating how chips 1000, 1001, 1002, . . . , each having a plurality of light emitting spots 1010, are arranged in the longitudinal direction. Note that light emitting spots are not illustrated in the chips 1001, 1002, . . . for the sake of simplicity. The chips may be LED array chips.

Japanese Patent Application Laid-Open No. H09-266329 reports an invention of dicing semiconductor chips for forming two-dimensionally arranged light emitting device arrays to make them show a parallelogrammic profile, devising an LED array chip that accommodates 1,200 dpi from the viewpoint of installation.

According to the above cited invention, the distance separating an end of an array chip (cut surface side) having two-dimensionally arranged light emitting spots and the light emitting part of the chip is increased to provide a wide margin for dicing the chip by tilting the adjacent end facets of the array chip relative to the long sides thereof. More specifically, four light emitting device arrays are arranged along the longitudinal direction of the chip to produce four rows.

When a light source apparatus is formed by arranging 1,200 dpi LED array chips in a row in a manner as described above, the gap separating the light emitting parts of neighboring chips can be increased from about 10 μm to about 26 μm to provide a wide margin for the dicing operation.

### SUMMARY OF THE INVENTION

Meanwhile, to realize 2,400 dpi, light emitting spots need to be arranged on a semiconductor at a pitch of about 10.6 μm and the size of the light source is required to be about 5 μm.

The currently available process technologies can realize such an arrangement of light emitting spots. However, a problem arises at the end parts of the LED array chip. More specifically, the following requirement needs to be met to realize a predetermined pitch of arrangement of light emitting spots at the junction 1500 of two neighboring chips.

Namely, the dicing margin, the chip installing space and the distance from the diced position to be secured to prevent any light emitting spot from being damaged should be not more than the gap of 10.6 μm separating two neighboring light emitting spots. However, the above requirement cannot be met because of the degree of accuracy of alignment for dicing and the move of the cutting blade that is unintentional and inevitable.

The inter-chip margin necessary for dicing chips may be secured by arranging light emitting spots of LED array chips (1000, 1001, 1002 in FIG. 6) not in a single row running in the longitudinal direction of the chip as illustrated in FIG. 6 but in a plurality of rows and additionally making the chip show a parallelogrammic profile by tilting the short sides 1600 of the chip relative to the long sides thereof.

However, further improvements are required for LED array chips that accommodate 2,400 dpi and greater dpi because the number of wires for driving the individual elements arranged on a chip is enormous.

In view of the above-identified circumstances, it is therefore the object of the present invention to realize a high density LED array chip of 2,400 dpi or greater dpi having light emitting spots that can be driven independently.

In the first aspect of the present invention, the above object is achieved by providing a light emitting device array chip comprising a light emitting device array having a plurality of light emitting devices arranged two-dimensionally on a substrate, wherein the profile of the light emitting device array chip is a parallelogram profile formed by two long sides and two short sides, each of the long sides and each of the short sides forming an acute angle or an obtuse angle, the light emitting device array has a plurality of blocks arranged along the long sides, each of the blocks has a plurality of segments arranged along the long sides, each of the segments is formed by arranging a plurality of light emitting devices connected to a common electrode and arranged in a plurality of rows along the long sides and also in a plurality of rows along the short sides, at least a single wire for electrically connecting a plurality of light emitting devices selected from segments that are different from each other is provided, an electrode pad for wire bonding is formed on the at least single wire, and the electrode pad in the block at an end of the light emitting device array chip is arranged at the side of the long side of a corner of the acute angles formed by the long sides and the short sides defining the profile of the light emitting device array chip.

According to the present invention, a high density LED array light source can be realized. At the same time, a high definition exposure light source can be realized because each of the light emitting devices in each block of the chip is driven independently and hence the drive circuit for time sharing drives can be connected by wire boding. Additionally, since each block can be electrically isolated, light emitting devices of different blocks can be driven simultaneously.

Further features of the present invention will become apparent from the following description of exemplary embodiments with reference to the attached drawings.

### BRIEF DESCRIPTION OF THE DRAWINGS

FIG. 1 is a schematic illustration of the pattern of an end part of a two-dimensionally arranged LED array chip according to the present invention.

FIG. 2 is an enlarged schematic illustration of neighboring end parts of array chips according to the present invention.

FIG. 3 is a schematic illustration of an arrangement of wires that can be used for an array chip according to the present invention.

FIG. 4 is a schematic illustration of another arrangement of wires that can be used for an array chip according to the present invention.

FIG. 5 is a schematic illustration of an exposure light source apparatus additionally having a rod lens array according to the present invention.

FIG. 6 is a schematic illustration of the configuration of the LED array of a known printer head.

### DESCRIPTION OF THE EMBODIMENTS

Now, the present invention will be described in greater detail by referring to the accompanying drawings that illustrate exemplary embodiments of the invention.

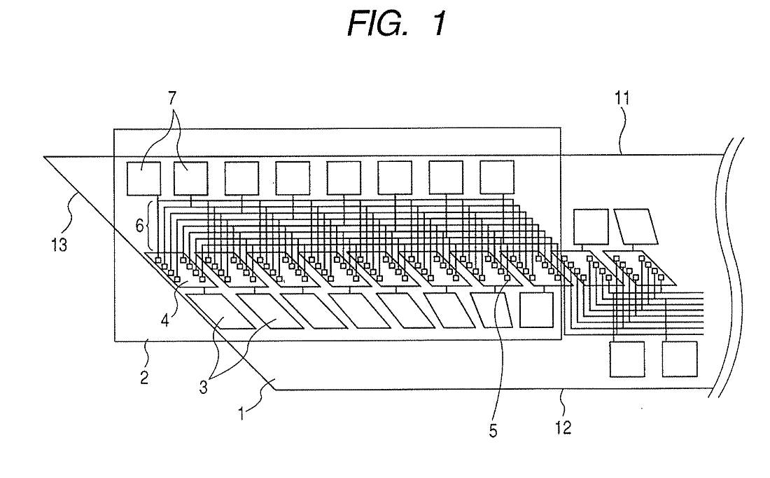

FIG. 1 is a schematic top view of a chip according to the present invention, illustrating an end part thereof, the chip being a 2,400 dpi light emitting device array chip 1 formed by two-dimensionally arranging a plurality of light emitting devices (light emitting spots) and electrodes on a substrate. A light emitting device array chip may conceptually be an LED array chip as described above and LEDs may be ordinary light emitting devices or laser devices.

The light emitting device array chip 1 is formed by arranging a plurality of light emitting devices 5 in array.

A block 2 includes typically eight segments (64 light emitting devices). In this regard, the number of blocks, the number of segments and the number of light emitting devices in a segment, provided in a light emitting device array chip can be arbitrarily selected depending on the necessity.

A segment 4 includes eight devices where a common electrode is used as one of the electrodes of each of the devices.

A common electrode pad 3 for wire bonding is connected to the common electrode (not illustrated) of each segment.

The light emitting devices (light emitting spots) 5 are arranged in four rows along the longitudinal direction of the light emitting device array chip 1.

Each wire 6 connects a plurality of light emitting devices selected from different segments.

Each electrode pad 7 for wire bonding is connected to a wire 6.

The present invention provides a light emitting device array chip having a light emitting device array formed by two-dimensionally arranging a plurality of light emitting devices on a substrate as illustrated in FIG. 1.

The light emitting device array chip has a parallelogrammic profile formed by a pair of long sides (11 and 12 in FIG. 1) and a pair of short sides (13 in FIG. 1). The parallelogram is not a rectangle and hence each of the long sides and each of the short sides form an acute angle or an obtuse angle.

The light emitting device array has a plurality of blocks 2 arranged in the longitudinal direction, or the direction running along the long sides 11 and 12.

Each block 2 has a plurality of segments 4 arranged in the longitudinal direction.

Each segment has a plurality of light emitting devices connected to a single common electrode and arranged in a plurality of rows running along the long sides and also in a plurality of rows running along the short sides. In FIG. 1, light emitting devices are arranged in four rows running along the long sides and in two rows running along the short sides.

At least a single wire (ordinarily wires as many as the number of light emitting devices of a segment) 6 is provided to electrically connect a plurality of light emitting devices selected from different segments 4 (ordinarily a light emitting device is selected from a segment).

An electrode pad 7 for wire bonding is formed for the at least single wire 6. The electrode pad 7 in the block at an end of the light emitting device array chip is arranged at the side of the long side 11 of a corner of the acute angles formed by the long sides and the short sides defining the profile of the light emitting device array chip 1. Preferably, the electrode pad located at an end of the light emitting device array chip is arranged at the side of the long side near a vertex where a long side and a short side form an acute angle.

With the above-described arrangement, the region produced by providing the chip 1 with a parallelogrammic (not rectangular) profile can be satisfactorily exploited for installation.

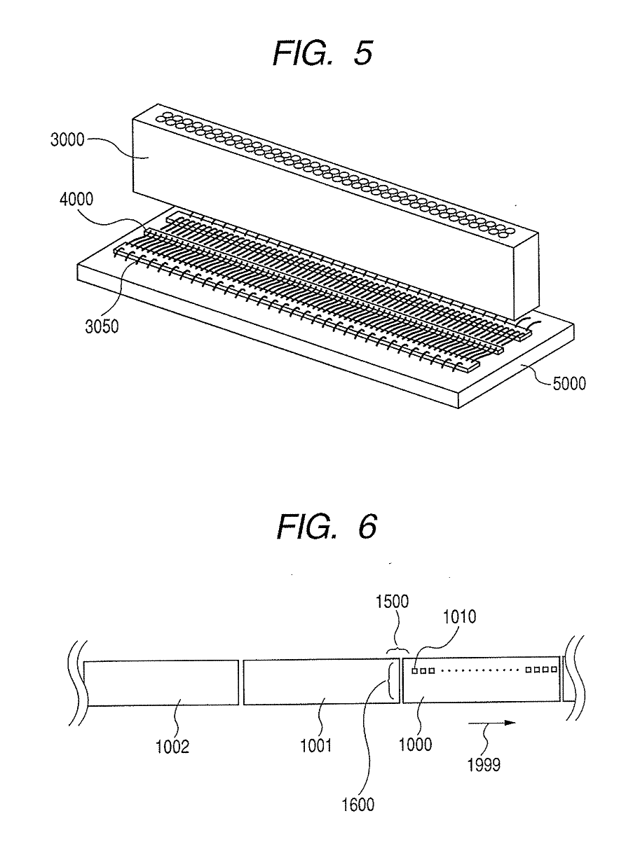

An exposure light source apparatus can be realized by arranging a rod lens array 3000 for condensing and focusing light radiated from a light emitting device array chip according to the present invention opposite to a chip 4000 on a wiring substrate 5000 as illustrated in FIG. 5. The chip 4000 of FIG. 5 is driven by a driver IC 3050.

A plurality of light emitting devices in a same block 2 can be driven in a time-sharing manner. A plurality of light emitting devices belonging to different blocks can be driven simultaneously.

According to the present invention, light emitting devices (light emitting spots) are arranged in a plurality of rows running along the long sides of the array chip. The short sides are tilted relative to the long sides in the direction of arrangement of the light emitting spots of the first row all the way to the light emitting spots of the fourth row. In other words, the array chip has a parallelogrammic (not rectangular) profile. With this parallelogrammic arrangement, the pitch of arrangement of light emitting spots is four times as large as that of a rectangular arrangement in a same row so that a sufficiently large margin can be secured for chip dicing.

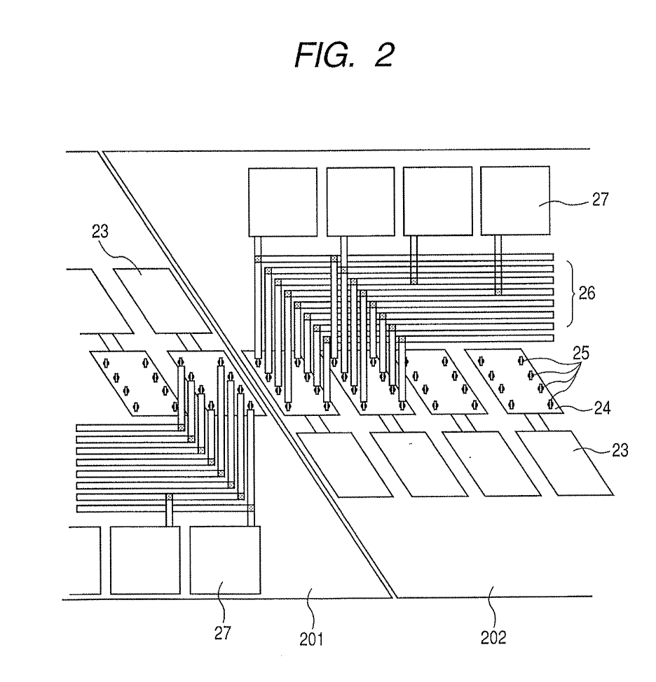

FIG. 2 is an enlarged schematic illustration of neighboring end parts of array chips of this embodiment. The plurality of (eight in this embodiment) light emitting spots 25 of each segment 24 share a single electrode (not shown). In other words, a set of a plurality of light emitting spots 25 that share a single electrode forms a segment 24.

The shared electrode is connected to a common electrode pad 23 for wire bonding.

The individual electrodes of the light emitting spots selected from each of the plurality of segments (ordinarily one from each segment) are connected at least by a single wire (ordinarily wires as many as the light emitting spots of a single segment) 26 to form a block. Each wire 26 is provided with an electrode pad 27 for wire boding.

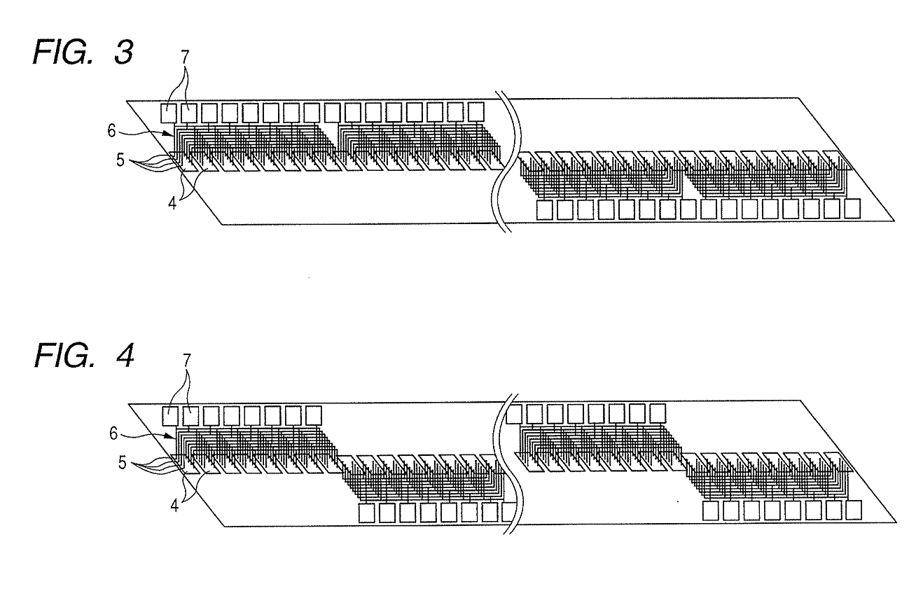

As illustrated in FIGS. 3 and 4, a plurality of blocks 2 are formed linearly continuously along the longitudinal direction of the array chip. The wire 6 connected to a plurality of segments within the block and the electrode pad 7 for wire boding at each of the opposite ends of the array chip are arranged at the side of the long side 11 near one of the vertexes of the acute angles formed by the long sides and the short sides defining the profile of the chip. The inter-segment wire 6 and the electrode pad 7 of each of the blocks other than the blocks at the ends may be arranged at the side same as the block at the side of the corresponding nearest chip end block as illustrated in FIG. 3 or at the opposite side as illustrated in FIG. 4.

As the inter-segment connection wire of each of the blocks at each of the opposite ends of the array chip is arranged at the side of the long side near one of the vertexes of the acute angles of the chip having a parallelogrammic profile, light emitting spots can be aligned in end parts of the array chip without producing excessive gaps and hence light emitting spots can be arranged at a predetermined pitch among a plurality of array chips.

In the block 2 of FIG. 1, the light emitting spots that correspond to the leftmost segment 4 are sequentially turned on as a voltage is applied to the electrode pads 7 sequentially from the leftmost electrode pad 7 connected to the common electrode pads 3 and the wires 6 of the leftmost segment 4. Similarly, the light emitting spots of the second segment from the left can be turned on by selecting the common electrode pad of the second segment. In this way, any selected light emitting spot in a block can be driven independently on a time-sharing manner. Since each block is electrically isolated, light emitting spots belonging to different blocks can be driven simultaneously.

A 2,400 dpi LED array light source apparatus can be realized by arranging 2,400 dpi LED array chips in a row over the A4 size along with a driver IC, a control circuit and an optical system for focusing light on a photosensitive drum. Such a light source apparatus can be utilized for a printer, a copying machine or an exposure light source apparatus.

### EXAMPLE

Now, the present invention will be described further by way of an example, referring to the drawings. However, the present invention is by no means limited to the example that will be described hereinafter.

Firstly, an n-GaAs layer, an n-AlₓGa₁₋ₓAs layer, a p-Al_{y}Ga_{1-y}As layer, a p-AlₓGa₁₋ₓAs layer and a p-GaAs layer (y<x) are sequentially formed on a GaAs substrate by epitaxial growth by means of a known technique.

While the impurity concentration and the thickness of each of the epitaxially grown layers depend on the design of the device, a typical arrangement is shown below.

n-GaAs layer: 0.05-0.5 μm; Si-doping

n-Al_{0.35}Ga_{0.65}As layer: about 1 μm; Si-doping

p-Al_{0.13}Ga_{0.87}As layer: about 0.5 μm; C-doping

p-Al_{0.35}Ga_{0.65}As layer: about 1 μm; C-doping

p-GaAs layer: 0.1-0.5 μm; C-doping.

Subsequently, two-dimensionally arranged surface emitting LEDs are formed on the epitaxially grown layers by means of a known semiconductor process.

After the end of the wafer process, the work is divided into semiconductor chips by means of a dicing apparatus. The semiconductor chips are cut out to dimensions showing long sides of about 8.14 mm and short sides of about 0.8 mm.

FIG. 1 is a schematic illustration of an end part of a 2,400 dpi LED array chip 1 according to the present invention. The array chip 1 is provided with wires 6 and wire bonding pads 3 and 7 for turning on each light emitting spot independently by a time-sharing drive. The light emitting spots 5 are arranged in four rows running along the long sides of the semiconductor chip. The short sides 13 are tilted relative to the long sides 11 in the direction of arrangement of the light emitting spots of the first row all the way to the light emitting spots of the fourth row. In other words, the chip array has a parallelogrammic (not rectangular) profile.

FIG. 2 is an enlarged schematic illustration of neighboring end parts of array chips 201 and 202. Each light emitting spot 25 of LED has a size of about 5 μm and light emitting spots are arranged to show such a pattern that they are arranged along the long sides of the chip at a pitch of 10.6 μm and in four rows in the direction perpendicular to the long sides at a pitch of 21.2 μm. Thus, the light emitting spots of a same row are arranged at a pitch of 42.4 μm that is four times of the above pitch. Then, as a result, as illustrated in FIG. 2, a gap sufficient for securing the dicing margin, the chip installing space and the distance from the diced position to be secured to prevent any light emitting spot from being damaged can be provided at a position where the surfaces produced by chip dicing are oppositely disposed.

Eight light emitting devices (light emitting spots) 5 share one of a pair of opposite electrodes and form a single segment 4 in FIG. 1. The common electrode is connected to a common electrode pad 3 for wire bonding. The individual electrodes of the eight devices selected from eight segments on a one from each basis are connected by a single wire 6 to form a block 2. Each of the eight wires 6 in a single block 2 is provided with an electrode pad 7 for wire bonding. The wire 6 connected to the eight segments within the block and the electrode pad 7 for wire boding at each of the opposite ends of the chip are arranged at the side of the long side near one of the vertexes of the acute angles formed by the long sides and the short sides defining the parallelogrammic profile of the chip.

FIG. 3 is a schematic illustration of an entire LED array chip. As illustrated in FIG. 3, the inter-segment wire 6 in the block at each of the longitudinal opposite ends of the chip is arranged at the side of the long side near one of the vertexes of the acute angles formed by the long sides and the short sides defining the parallelogrammic profile of the chip.

In the block 2 of FIG. 1, the light emitting spots that correspond to the leftmost segment 4 are sequentially turned on as the common electrode pad 3 of the leftmost segment 4 is selected and a voltage is applied to the eight electrode pads 7 sequentially from the leftmost electrode pad 7 connected to the wires 6. Similarly, the light emitting spots of the second segment can be turned on by selecting the common electrode pad 3 of the second segment. In this way, any selected light emitting spot 5 in a block can be driven independently on a time-sharing manner. Since each block 2 is electrically isolated, light emitting spots belonging to different blocks can be driven simultaneously.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-036360, filed Feb. 16, 2007, which is hereby incorporated by reference herein in its entirety.

What is claimed is:

1. A light emitting device array chip comprising a light emitting device array having a plurality of light emitting devices arranged two-dimensionally on a substrate, wherein
the profile of the light emitting device array chip is a parallelogram formed by two long sides and two short sides, each of the long sides and each of the short sides forming an acute angle or an obtuse angle,
the light emitting device array has a plurality of blocks arranged along the long sides,
each of the blocks has a plurality of segments arranged along the long sides,
each of the segments is formed by arranging a plurality of light emitting devices connected to a common electrode and arranged in a plurality of rows along the long sides and also in a plurality of rows along the short sides,
at least a single wire for electrically connecting a plurality of light emitting devices selected from segments that are different from each other is provided;
an electrode pad for wire bonding is formed on the at least single wire, and
the electrode pad in the block at an end of the light emitting device array chip is arranged at the side of the long side of a corner of the acute angles formed by the long sides and the short sides defining the profile of the light emitting device array chip.

2. An exposure light source apparatus comprising a light emitting device array chip according to claim 1 and a rod lens array for condensing and focusing light radiated from the light emitting device array chip.

3. The exposure light source apparatus according to claim 2, wherein a plurality of light emitting devices located in a same block are driven in a time-sharing manner.

4. The exposure light source apparatus according to claim 2, wherein a plurality of light emitting devices belonging to different blocks are driven simultaneously.
